(19) United States
(12) Patent Application Publication
(10) Pub. No.: US 2026/0079758 A1
(43) Pub. Date: Mar. 19, 2026

(54) HARDWARE RESOURCE PARTITIONING FOR SAFETY-RELATED APPLICATIONS

(71) Applicant: NVIDIA Corporation, Santa Clara, CA (US)

(72) Inventors: Anurag CHAUDHARY, San Jose, CA (US); Jasjit SINGH, Sacramento, CA (US); Shraddha GONDKAR, San Jose, CA (US); John Andrew KELLEY, Fort Collins, CO (US)

(73) Assignee: NVIDIA Corporation, Santa Clara, CA (US)

(21) Appl. No.: 18/885,215

(22) Filed: Sep. 13, 2024

(51) Int. Cl. G06F 9/50; G06F 11/34

(52) U.S. Cl. CPC G06F 9/5038; G06F 9/505; G06F 11/3433

(57) ABSTRACT

Systems and methods in accordance with the present disclosure can prevent interference of memory operations being performed, for example, by partitioning memory access to safety related applications and non-safety related applications. In various examples, one or more circuits can assign, to a workload for execution on a system-on-a-chip (SoC) and according to a criticality of the workload, at least one threshold for bandwidth of a resource of the SoC. The one or more circuits can control execution of the workload according to the at least one threshold.

### BACKGROUND

Systems-on-a-chip (SoCs) can include units that share memory sub-system resources. However, the sharing of memory sub-system resources can impact performance of the SoCs.

### SUMMARY

Implementations of the present disclosure relate to systems and methods for preventing interference between processes implemented on hardware architectures—such as a system-on-a-chip (SoC). In contrast to conventional systems, systems and methods in accordance with the present disclosure can implement performance partitioning by assigning one or more thresholds, to selectively control access to or use of a resource of the SoC, to workloads having mixed criticality. For example, an SoC may perform operations associated with safety related functions and non-safety related functions. To prevent the non-safety related functions from interfering with the safety related functions, thresholds of bandwidth of a resource may be assigned to define partitions.

At least one implementation relates to a system. The system can include one or more circuits. The one or more circuits can assign, to a workload for execution on a system-on-a-chip (SoC) and according to a criticality (e.g., priority, essentiality, cruciality, importance, severity) of the workload, at least one threshold for bandwidth of a resource of the SoC. The one or more circuits can control execution of the workload according to the at least one threshold.

In some implementations, the criticality can correspond to an automotive safety integrity level (ASIL) associated with the workload. In some implementations, the resource can include at least one of a memory element, an interconnect, or a cache of the SoC.

In some implementations, the one or more circuits can assign the at least one threshold, responsive to the criticality indicating that the workload satisfies a high criticality condition, to include a minimum threshold bandwidth to allocate to the workload and a maximum threshold bandwidth to selectively limit allocation of the resource to the workload responsive to the resource being in a state of contention.

In some implementations, the workload can be a first workload. The at least one threshold can be at least one first threshold. The criticality can be a first criticality. The one or more circuits can assign, to a second workload having a second criticality lower than the first criticality, at least one second maximum threshold for the bandwidth of the resource such that the one or more circuits prevent interference of the second workload with the first workload.

In some implementations, the one or more circuits can execute the workload using a partition associated with the SoC. The one or more circuits can map the at least one threshold to an identifier of the partition. In some implementations, the system can be included in at least one of a control system for an autonomous or semi-autonomous machine, a perception system for an autonomous or semi-autonomous machine, a system incorporating one or more virtual machines (VMs), a system implemented using a robot, a system implemented using an edge device, a system for generating synthetic data, a system comprising one or more large language models (LLMs), a system comprising one or more vision language models (VLMs), a system comprising one or more multi-modal language models, a system for performing conversational AI operations, a system for performing deep learning operations, a system for performing simulation operations, a system for performing collaborative content creation for 3D assets, a system for performing digital twin operations, a system for performing light transport simulation, a system implemented at least partially in a data center, or a system implemented at least partially using cloud computing resources.

At least one implementation relates to a system-on-a-chip (SoC). The SoC can include one or more circuits. The one or more circuits can assign, to a workload for execution on the SoC, according to a criticality of the workload, at least one threshold for bandwidth of a resource of the SoC. The one or more circuits can control execution of the workload according to the at least one threshold.

In some implementations, the criticality can correspond to an automotive safety integrity level (ASIL) associated with the workload. In some implementations, the resource can include at least one of a memory element, an interconnect, or a cache of the SoC.

In some implementations, the one or more circuits can assign the at least one threshold, responsive to the criticality indicating that the workload satisfies a high criticality condition, to include a minimum threshold bandwidth to allocate to the workload and a maximum threshold bandwidth to selectively limit allocation of the resource to the workload responsive to the resource being in a state of contention.

In some implementations, the workload can be a first workload. The at least one threshold can be at least one first threshold. The criticality can be a first criticality. Th one or more circuits can assign, to a second workload having a second criticality lower than the first criticality, at least one second maximum threshold for the bandwidth of the resource such that the one or more circuits prevent interference of the second workload with the first workload.

In some implementations, the one or more circuits can execute the workload using a partition associated with the SoC, and the one or more circuits are to map the at least one threshold to an identifier of the partition. In some implementations, the SoC can be included in at least one of a control system for an autonomous or semi-autonomous machine, a perception system for an autonomous or semi-autonomous machine, a system incorporating one or more virtual machines (VMs), a system implemented using a robot, a system implemented using an edge device, a system for generating synthetic data, a system comprising one or more large language models (LLMs), a system comprising one or more vision language models (VLMs), a system comprising one or more multi-modal language models, a system for performing conversational AI operations, a system for performing deep learning operations, a system for performing simulation operations, a system for performing collaborative content creation for 3D assets, a system for performing digital twin operations, a system for performing light transport simulation, a system implemented at least partially in a data center, or a system implemented at least partially using cloud computing resources.

At least one implementation relates to a method. The method can include assigning, by one or more circuits, to a workload for execution on a system-on-a-chip (SoC), according to a criticality of the workload, at least one threshold for bandwidth of a resource of the SoC. The method can include controlling, by the one or more circuits, execution of the workload according to the at least one threshold.

In some implementations, the criticality can correspond to an automotive safety integrity level (ASIL) associated with the workload. In some implementations, the resource can include at least one of a memory element, an interconnect, or a cache of the SoC.

In some implementations, the method can include assigning, by the one or more circuits, the at least one threshold, responsive to the criticality indicating that the workload satisfies a high criticality condition, to include a minimum threshold bandwidth to allocate to the workload and a maximum threshold bandwidth to selectively limit allocation of the resource to the workload responsive to the resource being in a state of contention.

In some implementations, the workload can be a first workload, the at least one threshold can be at least one first threshold, and the criticality can be a first criticality. The method can include assigning, by the one or more circuits, to a second workload having a second criticality lower than the first criticality, at least one second maximum threshold for the bandwidth of the resource such that the one or more circuits prevent interference of the second workload with the first workload.

In some implementations, the method can include executing, by the one or more circuits, the workload using a partition associated with the SoC. The method can include mapping, by the one or more circuits, the at least one threshold to an identifier of the partition.

### BRIEF DESCRIPTION OF THE DRAWINGS

The present systems and methods for performance partitioning are described in detail below with reference to the attached drawing figures, wherein:

FIG. 1 is a block diagram of an architecture, in accordance with some implementations of the present disclosure;

FIG. 2 is a block diagram of performance partitioning implemented by circuitry of a system-on-a-chip (SoC), in accordance with some implementations of the present disclosure;

FIG. 3 is a flow diagram of a process for performance partitioning, in accordance with some implementations of the present disclosure;

FIG. 4A is an illustration of an example autonomous vehicle, in accordance with some implementations of the present disclosure;

FIG. 4B is an example of camera locations and fields of view for the example autonomous vehicle of FIG. 4A, in accordance with some implementations of the present disclosure;

FIG. 4C is a block diagram of an example system architecture for the example autonomous vehicle of FIG. 4A, in accordance with some implementations of the present disclosure;

FIG. 4D is a system diagram for communication between cloud-based server(s) and the example autonomous vehicle of FIG. 4A, in accordance with some implementations of the present disclosure; and

FIG. 5 is a block diagram of an example computing device suitable for use in implementing some implementations of the present disclosure.

### DETAILED DESCRIPTION

Systems and methods for partitioning of computing resources, such as performance partitioning for mixed criticality workloads, are described herein. Some systems can have criteria to have freedom from interference (FFI) for one or more workloads, such as high criticality workloads. For example, FFI can be defined (e.g., in ISO 26262) as the absence of cascading failures between two or more elements that could lead to the violation of a safety requirement. For example, FFI can require that a fault in a system or sub-system with a less critical automotive safety integrity level (ASIL) not affect the functioning of a higher ASIL system or sub-system.

Although primarily described with respect to SoCs, the processes and systems described herein may additionally or alternatively be implemented with any hardware resources, such as SoCs, discrete processors, portions of processors, virtual processors (e.g., vGPU, vCPU, etc.), ASICs, FPGAs, accelerators (e.g., deep learning accelerators (DLAs), optical flow accelerators (OFAs), programmable vision accelerators (PVAs), etc.), and/or other processing, memory, storage, compute, and/or other resource types.

Computing resources used in automotive systems, among other environments, can rely on systems-on-a-chip (SoCs). The SoCs can have many cores, which can share memory sub-system resources. These resources can include interconnect bandwidth, system level cache capacity, and memory bandwidth, for example. However, situations such as execution of processes and/or workloads (e.g., software processes) that have varied criticality can have a greater likelihood of interfering with each other when deployed in SoC environments, as a first process can cause a second process to fail. For example, the first process may access greater resources than a level at which the second process has access to remaining resources to operate, which can result in errors or failure of operation of the second process.

Some approaches to address FFI include running processes that have different criticality on different SoCs, or statically partitioning memory subsystem resources (e.g., in a single SoC) to satisfy the FFI criteria. However, the former results in greater system hardware needs due to the requirement of multiple SoCs, and the latter can result in inefficient utilization (e.g., under-utilization) of resources of the SoC, such as under-utilization of memory subsystem resources.

Systems and methods in accordance with the present disclosure can control hardware resources, such as memory communication and/or bandwidth, in accordance with one or more rules, policies, and/or heuristics that allow for higher priority and/or higher safety related processes to be performed without interference from lower priority and/or lower safety-related processes. The higher priority processes can include, for example, safety-related, more critical, and/or higher ASIL processes. The lower priority processes can include, for example, non-safety-related, less critical, and/or lower ASIL processes.

For example, the system can assign an identifier, such as a partition identifier, to one or more processes and/or applications, and can control access to resources for use by the one or more processes and/or applications according to the partition identifier. The partition identifier can indicate a priority (e.g., criticality, essentiality, cruciality, importance, severity) of the process and/or be mapped to the priority.

The system can perform the control for resources such as data plane memory, which can include, for example, bandwidth for traffic destinations such as system level cache (SLC), local data plan memory (DRAM (CMEM)), and/or remote data plane memory (RMEM)—e.g., chip-to-chip connections between dies and/or sockets of chips, such as by an interconnect. The system can perform the control for resources such as control plane memory, e.g., memory mapped input output (MMIO) space. The system can perform the control for resources such as a last level shared cache, which can allow for quality of service (QoS) to be managed on a per partition basis. The system can perform the control based on access to resources such as registers and/or control registers.

In some implementations, the system assigns one or more thresholds for resource usage to a process. The system can assign the thresholds according to the identifier for the process, such as to assign the thresholds based at least on the priority of the process indicated by or mapped to the identifier. This can allow the system to provide bandwidth control for each partition. The system can assign thresholds including a minimum bandwidth (e.g., minimum bandwidth allocation), which can be a minimum bandwidth for the partition even in the presence of contention from other partitions. The thresholds can include a maximum bandwidth (e.g., maximum bandwidth allocation), which can be a maximum bandwidth that a partition can be allocated. This bandwidth control can ensure that each partition has bandwidth maintained in a target range even if contention may occur.

The system can selectively manage how strict the bandwidth thresholds are for a given partition based on factors such as the priority of the partition. For example, strict thresholds (e.g., strict maximum) can be applied to partitions that are non-safety-related and/or non-quality-managed. Non-strict thresholds (e.g., non-strict maximum) can be applied to partitions that are safety-related and/or of relatively higher priority, such as to allow at least temporary exceeding of the maximum bandwidth threshold under conditions such as light loading (e.g., where greater resources can be allocated to the partition) and/or low or no contention. The system can use any of various resource monitoring and/or control tools to manage bandwidth for the resources described herein, including cache, local memory, and chip to chip bandwidth.

Systems and methods in accordance with the present disclosure can allow for isolation between various processes associated with any of various clients (e.g., clients associated with computational engines and/or accelerators) as appropriate for preventing interference between different ASIL level processes. For example, the clients can be used to implement engines such as for video encoding or decoding operations. The isolation can be performed without the need for multiple SoCs, which can reduce hardware requirements for implementing the clients, such as to reduce size, weight, and/or power requirements.

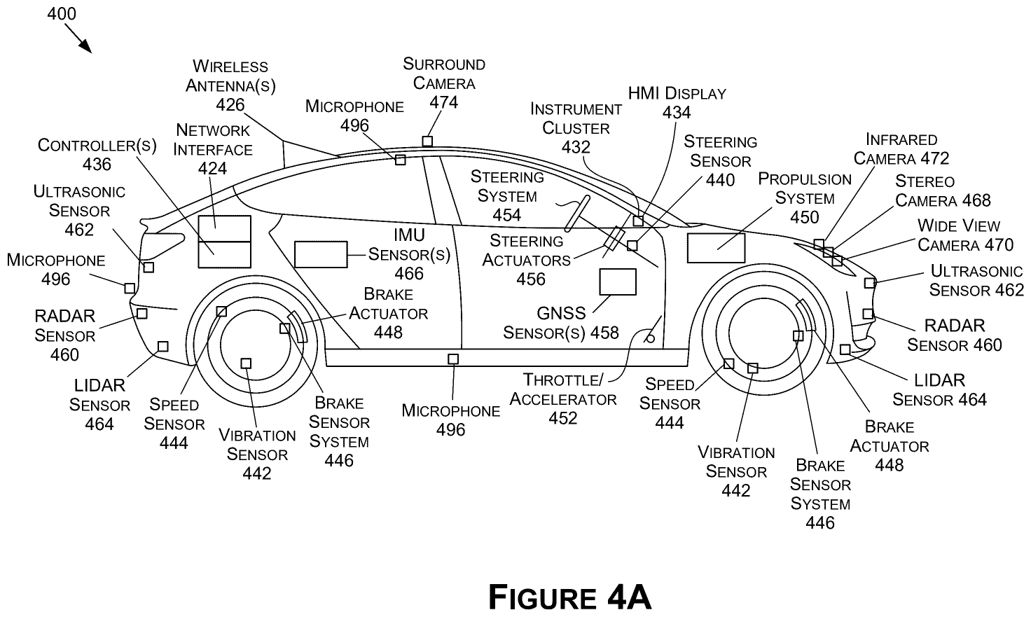

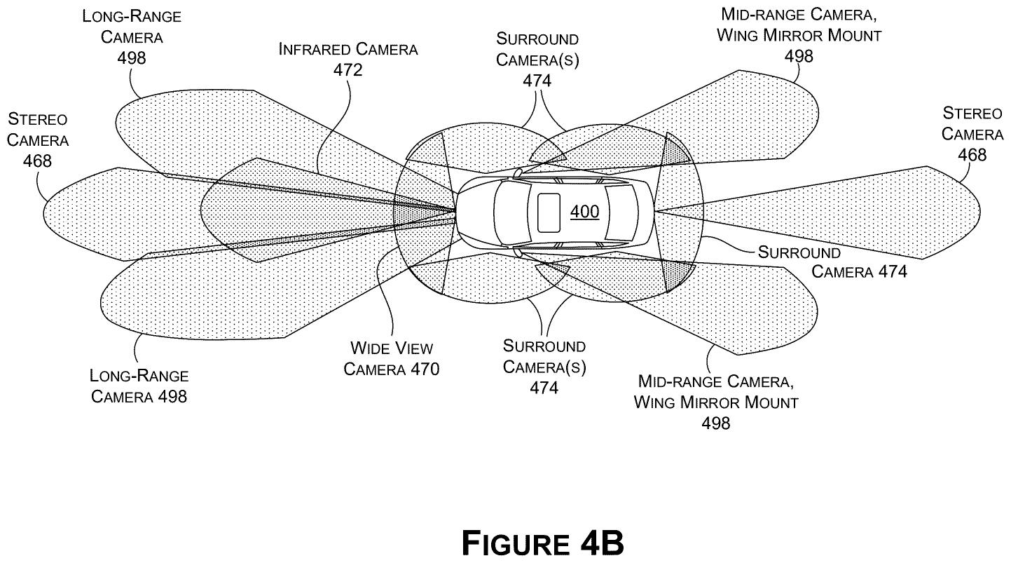

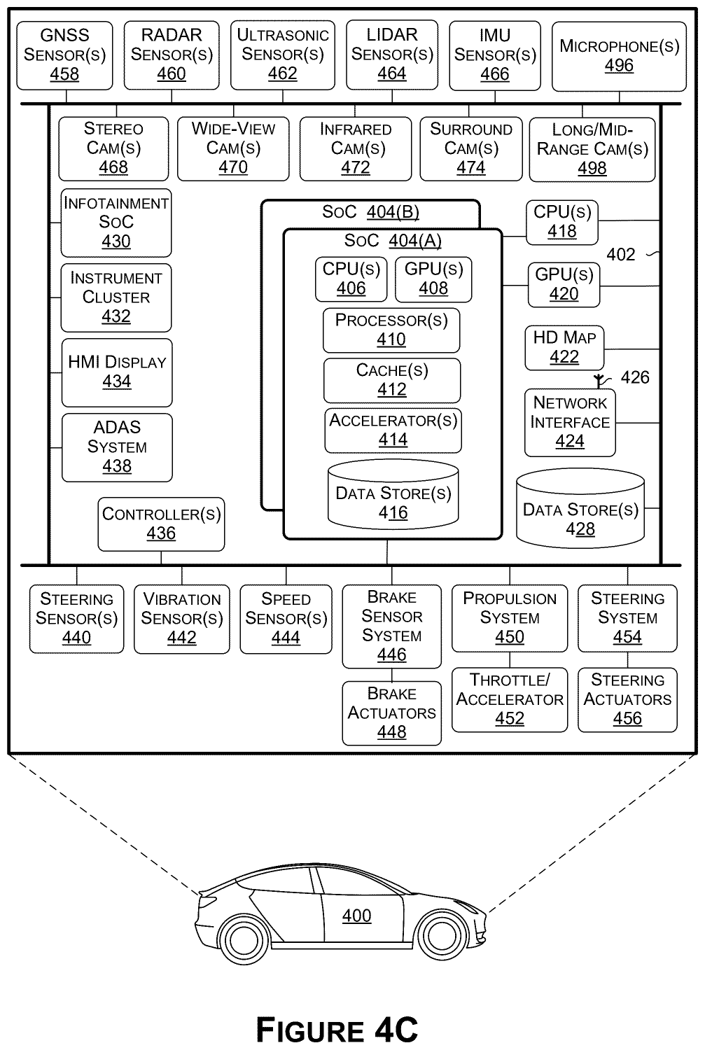

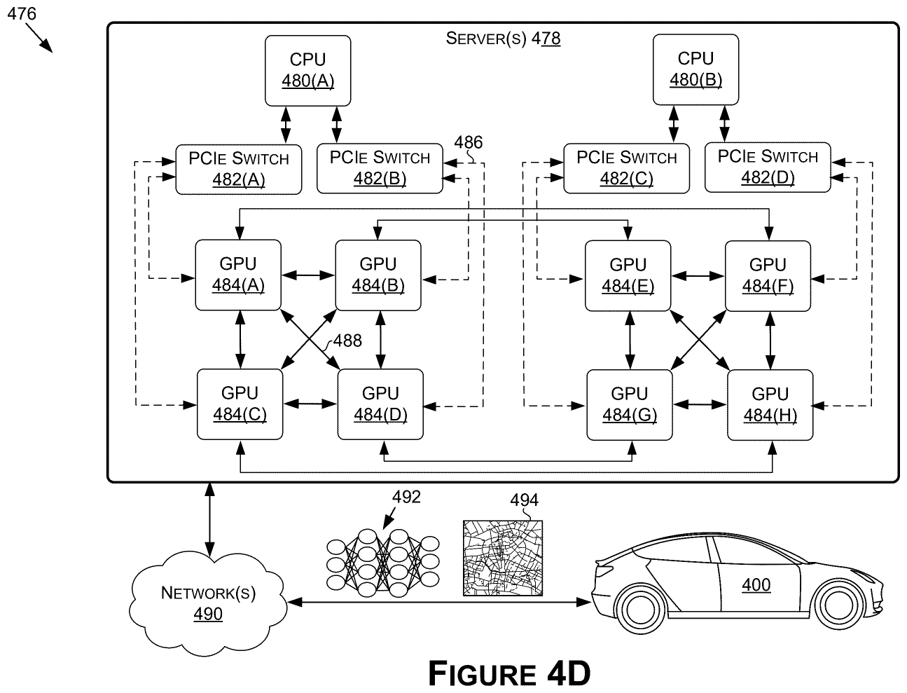

Although the present disclosure may be described with respect to an example autonomous or semi-autonomous vehicle or machine 400 (alternatively referred to herein as “vehicle 400,” “ego-vehicle 400,” “machine 400,” and/or “ego-machine 400,” an example of which is described with respect to FIGS. 4A-4D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to SMMU performance isolation for various ASIL level requests, this is not intended to be limiting, and the systems and methods described herein may be used in augmented reality, virtual reality, mixed reality, robotics, security and surveillance, autonomous or semi-autonomous machine applications, and/or any other technology spaces where virtual memory addressed may be translated to physical memory addresses.

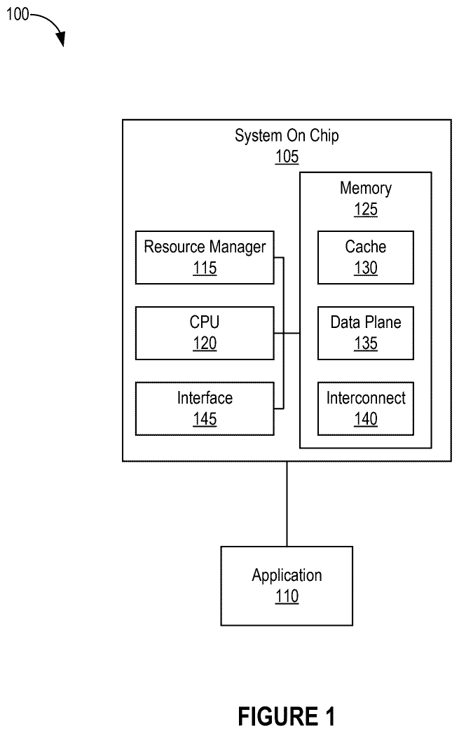

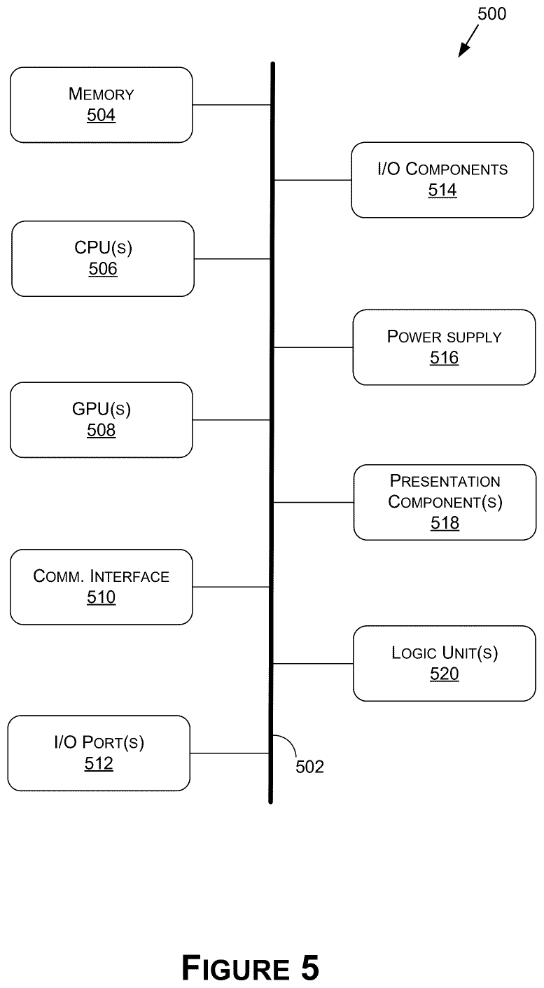

FIG. 1 depicts an architecture 100 (e.g., system 100), in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory. In some implementations, the systems, methods, and processes described herein can be executed using similar components, features, and/or functionality to those of example autonomous vehicle 400 of FIGS. 4A-4D and/or example computing device 500 of FIG. 5.

The architecture 100 can include at least one system-on-a-chip (SoC) 105. For example, the SoC 105 can include various components and/or circuity housed and/or located within a single device. The SoC 105 and/or one or more components thereof can perform at least one of the various processes and/or techniques described herein. For example, the SoC 105 can perform the performance partitioning described herein. The architecture 100 can include and/or execute at least one application 110. For example, the architecture 100 can include at least one of engines, drivers, software agents, virtual devices, partitions, and/or a unit having an allocated amount of physical memory.

In some implementations, the application 110 can refer to and/or include units that perform operations, such as autonomous functions, semi-autonomous functions, ADAS functions, user experience (UX) or in-cabin experience (IX) functions, infotainment functions, and/or cluster functions. For example, a first application 110 can perform object recognition. As another example, a first application 110 can control an instrument cluster within a vehicle. In some implementations, the applications 110 can refer to and/or include mixed critically workloads. For example, the applications 110 can have perform safety related functions and non-safety related functions. In some implementations, a safety related function can refer to and/or include automatic control of a vehicle. A non-safety related function can refer to and/or include controlling cockpit functions within a vehicle.

The SoC 105 can include components such as one or more of a resource manager 115, central processing unit (CPU) 120, memory 125, and/or interface 145. The SoC 105 may include other components as well, such as those described here with respect to FIGS. 4A-4D (e.g., accelerators). The various components of the SoC 105 can be communicably coupled with one another. For example, the resource manager 115 can communicate with the CPU 120. In some implementations, the interface 145 can communicably couple one or more components of the architecture 100 with one another. For example, the interface 145 can communicably couple the resource manager 115 with the applications 110. In some implementations, the interface 145 can couple instructions with hardware. For example, the interface 145 can refer to and/or include a kernel (e.g., a computer program) to connect application software with hardware. As another example, the interface 145 can include one or more device drivers that provide a software interface to the circuitry (e.g., hardware) of the SoC 105.

In some implementations, the SoC 105 can include one or more processors and memory (e.g., processing circuits) to perform at least one of the functions and/or actions described herein. For example, the SoC 105 may store (in memory 125) one or more instructions (e.g., software, executable code, firmware, etc.) that cause one or more processors to perform the actions of the resource manager 115. For example, memory 125 can store instructions to cause the resource manager to selectively allocate and/or partition bandwidth (e.g., memory resources) for the application 110. In some implementations, the resource manager 115 can interface with and/or control the memory 125 to adjust, modify, and/or change bandwidth provided to the applications 110.

In some implementations, the resource manager 115 can implement and/or include one or more memory management units. For example, the resource manager 115 can perform memory translations. As another example, the resource manager 115 can implement one or more memory access protocols to access memory 125. Memory 125 can refer to and/or include one or more types of memory. For example, memory 125 can include cache 130, data plane 135, and interconnect 140. The cache 130 can refer to and/or include at least one of system level cache, last level shared cache, random access memory (RAM), and/or other possible volatile memory. The data plane 135 can refer to and/or include data plane memory, local data plane memory, control plane memory, and/or memory to store information exchanged by the SoC 105. The interconnect 140 can refer to and/or include memory for a multi-die system connected via chip-to-chip interconnect.

In some implementations, the CPU 120 can include multiple cores, execution units, registers, and/or units to perform one or more operations. For example, the CPU 120 can include an execution unit to process information provided by the applications 110. As another example, the CPU 120 can include an execution unit to retrieve information stored in memory 125. In some implementations, the resource manager 115 can allocate and/or partition one or more portions of the CPU 120 for the applications 110. For example, the resource manager 115 can allocate a first number of cores, of the CPU 120, to a first application 110. As another example, the resource manager 115 can adjust a number of cores of the CPU 120 assigned to a second application 110.

As an example, the cache 130 can include a given amount of memory or space (e.g., 4 gigabytes, 500 megabytes, etc.). The resource manager 115 can allocate a threshold for the application 110 by adjusting a number of memory blocks, portions, and/or segments of the cache 130 available to the application 110. For example, the resource manager 115 can allocate a first amount (e.g., a first number of memory blocks) of the cache 130 to a first application 110. For example, the resource manager 115 can enable the first application 110 to utilize and/or interface with the first amount of the cache 130.

In some implementations, the resource manager 115 can implement one or more protocols, system calls, instruction set architectures, and/or specifications to allocate units of the CPU 120 and/or portions (e.g., space) of memory 125. For example, the resource manager 115 can implement advanced RISC machines (ARM) specifications, such as memory system resource partitioning and monitoring (MPAM). As another example, the resource manager 115 can execute one or more memory management calls to adjust an amount of memory that is allocated to the applications 110.

In some implementations, the SoC 105 and/or one or more components thereof can be included in and/or integrated with one or more systems. For example, the resource manager 115 can be included in at least one of a control system for an autonomous or semi-autonomous machine, a perception system for an autonomous or semi-autonomous machine, a system incorporating one or more virtual machines (VMs), a system implemented using a robot, a system implemented using an edge device, a system for generating synthetic data, a system comprising one or more large language models (LLMs), a system implementing one or more vision language models (VLMs), a system implementing one or more multi-modal language models, a system for performing conversational AI operations, a system for performing deep learning operations, a system for performing simulation operations, a system for performing collaborative content creation for 3D assets, a system for performing digital twin operations, a system for performing light transport simulation, a system implemented at least partially in a data center, and/or a system implemented at least partially using cloud computing resources.

In some implementations, the resource manager 115 can assign at least one threshold to a workload. For example, the resource manager 115 can allocate (e.g., assign) a percentage of memory 125 for a first application 110. As another example, the resource manager 115 can assign threshold values and/or threshold ranges for a bandwidth of memory 125. In some implementations, the resource manager 115 can establish a maximum amount of bandwidth (e.g., amount of memory) that is available (e.g., allocated, assigned, etc.) to the applications 110. For example, the resource manager 115 can set aside a first number of memory banks and/or rows of memory for a first application 110.

In some implementations, the resource manager 115 can assign thresholds accordingly to a level of strictness. For example, the resource manager 115 can assign a strict minimum threshold for a first application 110 by establishing that the threshold of bandwidth, assigned to the first application 110, cannot drop below a given value. Stated otherwise, the resource manager may assign a strict minimum threshold such that the threshold of bandwidth cannot drop below the threshold. In some implementations, the resource manager 115 can assign strict thresholds based on the criticality of the applications 110. For example, the resource manager 115 may assign a strict minimum threshold to a first application 110 based on the first application 110 corresponding to safety related functions. As another example, the resource manager 115 may elect to no assign a strict minimum threshold to a second application 110 based on the second application 110 being associated with non-safety related functions. Stated otherwise, the resource manager 115 may assign strict minimum threshold to applications 110 that are associated with safety related functions to ensure that the threshold of bandwidth does not drop between the minimum.

In some implementations, the resource manager 115 can assign strict maximum thresholds. For example, the resource manager 115 can assign a strict maximum threshold, for a given application 110, such that the threshold of bandwidth, assigned to the given application 110, does not exceed the maximum threshold. In some implementations, the resource manager 115 can assign non-strict minimum and/or maximum threshold. Stated otherwise, the resource manager 115 may not place any caps or restrictions on thresholds of bandwidth to assign to the applications 110.

In some implementations, the resource manager 115 can assign the at least one threshold (e.g., assign bandwidth associated with the at least one threshold) according to a criticality of the workload. For example, the resource manager 115 can assign more bandwidth to a first application 110 that is associated with safety related functions compared to a second application 110 that is associated with non-safety related functions. In some implementations, the criticality of the workload can be based on the ASIL range. For example, a first workload can be assigned high criticality based on the first workload being associated with ASIL D functions. As another example, a second workload can be assigned low criticality based on the second workload being associated with non-ASIL functions.

In some implementations, the resource manager 115 can control execution of at least one workload. For example, the resource manager 115 can control execution of a first application 110 (and/or one or more operations or processes of the first application 110) by allocating and/or reallocating the threshold for bandwidth. For example, the resource manager 115 can adjust and/or change amounts of memory (e.g., resources) that are allocated for the first application 110. As another example, the resource manager 115 can control execution by monitoring interactions with memory 125 to detect when to deallocate and/or reassign portions of memory 125.

In some implementations, the resource manager 115 can assign the threshold as a threshold for bandwidth of one or more resources of the SoC 105. For example, the resource manager 115 can assign a given amount of the cache 130 to a first application 110. As another example, the resource manager 115 can reallocate, from the first application 110, amounts of the cache 130 to a second application 110. In some implementations, the resource manager 115 can assign bandwidth to one or more resources, such as a memory element, an interconnect, or a cache. For example, the resource manager 115 can assign bandwidth to memory 125 and/or one or more components thereof (e.g., the cache 130, the data plane 135, the interconnect 140, etc.).

In some implementations, the resource manager 115 can assign bandwidth according to one or more minimum and/or one or more maximum values. For example, resource manager 115 can establish that a first application 110 be provided at least a first given amount of memory (e.g., a minimum bandwidth). The resource manager 115 can determine the first given amount of memory based on and/or according to a criticality of the application 110 having the allocation. For example, the resource manager 115 can select minimum bandwidth values for the applications 110 based on a criticality associated with the applications. The minimum bandwidth can be a predetermined or expected bandwidth at which the first application 110 is capable of operating at a target performance level (e.g., target level for minimizing errors or faults).

In some implementations, the resource manager 115 can establish that a first application 110 cannot be provided with more resources than a given amount of memory (e.g., a maximum bandwidth). For example, the resource manager 115 can assign an amount of memory for a given application 110 and can further restrict the resources available to the given application 110 such that the resources do not exceed the given amount of memory.

In some implementations, the resource manager 115 can allocate and/or reallocate bandwidth to prevent interference of a second workload. For example, the resource manager 115 can prevent interference by deallocating a bandwidth assigned to a first application 110 (e.g., a workload) to open up and/or create bandwidth for a second application 110 (e.g., a workload). As another example, the resource manager 115 can prevent interference by restricting bandwidth assigned to non-safety related functions (e.g., low and/or reduced criticality). The resource manager 115 can perform the allocation and/or reallocation according to the at least one threshold assigned to the first application 110 (e.g., to decrease the bandwidth allocated to the first application 110 up to but no lower than the minimum bandwidth for the first application 110). The resource manager 115 can perform the allocation and/or reallocation responsive to detecting a request for use of the memory 125 by the second application 110.

In some implementations, the resource manager 115 can execute the workload by implementing a partition. For example, the resource manager 115 can execute a given application 110 by allocating (e.g., partitioning) a given amount of resources, from memory 125, for the given application 110. In some implementations, the given number of resources can refer to and/or include a partition (e.g., a portion of memory) to execute one or more functions and/or processes of the application 110. For example, the resource manager 115 can use a partition of memory 125 to execute the workload by providing the amount of memory to a given application 110.

In some implementations, the resource manager 115 can map and/or link the thresholds to one or more identifiers, such as identifiers associated with the applications 110 and/or partitions. For example, the resource manager 115 can map a given amount of resources, allocated for an application 110, by associated the given amount of resources with an identifier of the application 110. In some implementations, the resource manager 115 can map the thresholds according to partition identifiers defined by the MPEM specification. The resource manager 115 can allocate and/or reallocate bandwidth based on the identifiers of the applications 110. For example, the resource manager 115 can call out and/or indicate a partition identifiers for a given application 110 to have the operating system adjust (e.g., allocate, reallocate, deallocate, etc.) the amount of resources (e.g., bandwidth, threshold, etc.) partitioned for the given application 110. As another example, the resource manager 115 can perform one or more system calls to identify the given application 110 and to identify the amount of resources to partition for the given application 110.

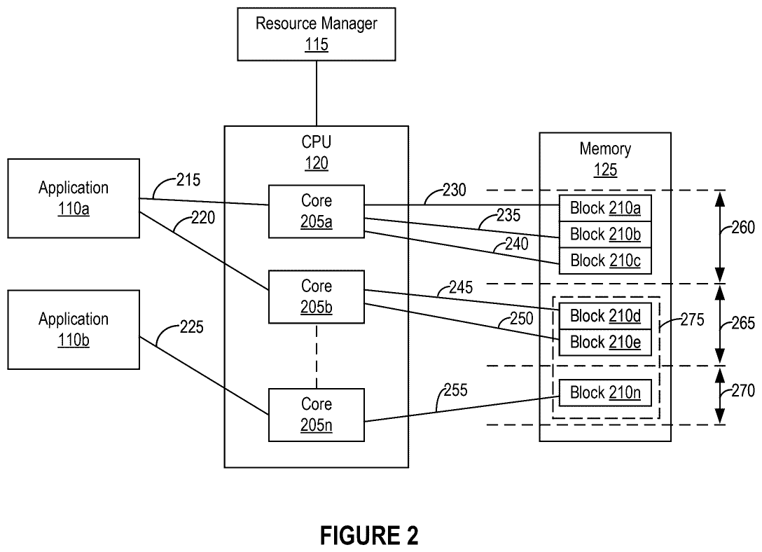

FIG. 2 is a block diagram of performance partitioning implemented by circuitry of a system-on-a-chip (SoC), according to some implementations. For example, the SoC 105 and/or one more components thereof can implement and/or execute the performance partitioning illustrated in FIG. 2. The SoC 105 can implement the performance partitioning, illustrated in FIG. 2, by allocating, reallocating, and/or deallocating one or more thresholds of bandwidth. In some implementations, the resource manager 115 can assign a threshold for the applications 110. For example, as shown in FIG. 2, the resource manager 115 has assigned one or more resources of the CPU 120 for an application 110a and an application 110b. In some implementations, the resource manager 115 can assign resources of the CPU 120 by allocating at least one core 205 of the CPU 120. For example, as shown in FIG. 2, the resource manager 115 has assigned core 205a and core 205b to the application 110a (as indicated by lines 215 and 220). As another example, the resource manager 115 has assigned core 205n to the application 110b (as indicated by line 225). In some implementations, the cores 205 can refer to and/or at least one of execution units, control sequence units, processing units, and/or control units that perform one or more processes of the CPU 120.

In some implementations, the resource manager 115 can assign resources of memory 125 by allocating at least one block 210 of memory 125. For example, the blocks 210 can refer to and/or include memory cells, memory pages, virtual memory rows, memory banks, and/or logical units of memory. As shown in FIG. 2, the resource manager 115 has assigned blocks 210a, blocks 210b, and blocks 210c to core 205a (as indicated by lines 230, 235, and 240), which is assigned to the application 110a. As another example, the resource manager 115 has assigned block 210d and block 210e (as indicated by lines 245 and 250), to core 205b, which is assigned to the application 110a.

In some implementations, the assignment and/or allocation of the blocks 210 can refer to and/or include an assignment of thresholds of bandwidth. For example, as shown in FIG. 2, the allocation of the blocks 210a, 210b, and 210c is shown to represent a given threshold of bandwidth (as indicated by line 260) of memory 125. For example, the allocations of the blocks 210a, 210b, and 210 represents how much of memory 125 (and/or one or more portions thereof) has been allocated to and/or assigned the core 205a.

As another example, as shown in FIG. 2, the resource manager 115 has assigned blocks 210d and 210e (as indicated by lines 245 and 250) to the core 205b. The assignment of the blocks 210d and 210e is shown to represent a threshold of bandwidth (as indicated by line 265) assigned to the core 205b. As another example, the resource manager 115 has assigned block 210n to core 205n (as indicated by line 255). The assignment of the block 210n is shown to represent a threshold bandwidth (as indicated by line 270) assigned to the core 205n.

In some implementations, the resource manager 115 can combine and/or allocate thresholds assigned to separate units (e.g., applications 110, cores 205, blocks 210, etc.) such that the thresholds may be shared by the separate units. For example, as illustrated in FIG. 2, the blocks 210d, 210e, and 210n are shown as a combined unit 275. Stated otherwise, the thresholds allocated to the core 205b and the core 205n may be combined such that the application 110a and the application 110b may have access to the blocks 210d, 210e, and 210n.

In some implementations, the resource manager 115 can monitor utilization of the combined unit 275 by both the application 110a and the application 110b to ensure that utilization of the combined unit 275 does not exceed the total amount of bandwidth associated with the combined unit 275. Stated otherwise, the resource manager 115 can monitor utilization of the combined unit 275 to ensure that the activity of the application 110a and/or the application 110b does not exceed the bandwidth associated with the blocks 210d, 210e, and 210n. In some implementations, the resource manager 115 can monitor multiple units (e.g., the application 110a and the application 110b) to provide a variable allocation of resources (e.g., the combined unit 275) to the multiple units. For example, the applications 110a and 110b may have additional resources such that the application 110a or the application 110b may exceed their individual thresholds by tapping into the additional resources provided by the combined unit 275.

In some implementations, the sharing and/or combination of resources provide flexibility for the application 110a and the application 110b as both units have access to the combined unit 275. This provides for flexibility of operation regarding utilization of resources. For example, the application 110a may have access to the block 210n while the application 110b is inactive and/or not using the block 210n. As another example, the application 110b may have access to the block 210d and the block 210e while the core 205b is inactive. This sharing of resources increases performance as the resource manager 115 does not need to deallocate resources from the application 110a and then allocate the resources to the application 110b. Instead, the resource manager 115 can manage utilization of the blocks 210d, 210e, and 210n between the application 110a and the application 110b.

In some implementations, the resource manager 115 may assign the combined unit 275 to the applications based on usage rates (e.g., peak bandwidth, average bandwidth, etc.) such that active applications (e.g., frequent actions, heavy traffic, etc.) are paired with routinely inactive applications (e.g., minimum actions, low traffic, etc.). Stated otherwise, busy applications may be paired with idle applications to decrease the likelihood of both applications being routinely active at the same time.

In some implementations, the resource manager 115 can assign and/or reassign one or more thresholds by adjusting and/or charging the cores 205 and/or the blocks 210 allocated for a given application 110. For example, the resource manager 115 can reduce a threshold for the application 110a by deallocating at least one of the core 205b or the core 205b. For example, the resource manager 115 can unassign and/or deallocate the core 205b and/or the core 205b to adjust (e.g., reduce) the threshold of bandwidth for the application 110a. As another example, the resource manager 115 can deallocate at least one block (e.g., the blocks, 210a, 210b, 210c, 210d, 210e) to adjust a threshold assigned to the application 110a.

In some implementations, the assignment of the cores 205 and/or the blocks 210 can refer to and/or include one or more partitions. For example, the assignment of the core 205b, to the application 110a, can represent a partition of the application 110a. As another example, the assignment of the block 210n, to the core 205n, can represent a partition for the core 205n and/or the application 110b.

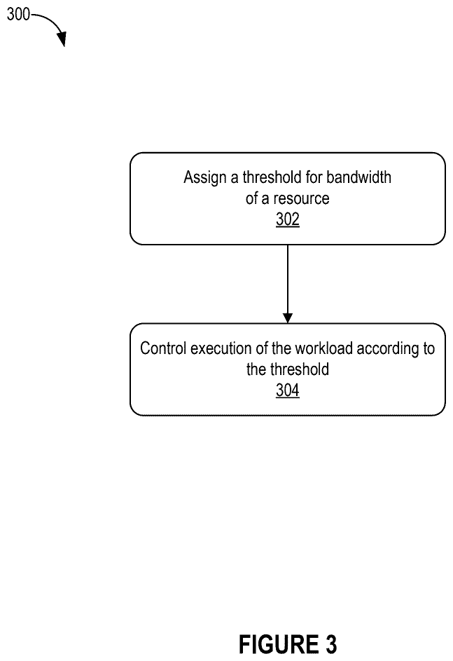

Now referring to FIG. 3, each block of method 300, described herein, comprises a computing process that can be performed using any combination of hardware, firmware, and/or software. For instance, various functions can be carried out by a processor executing instructions stored in memory. The method 300 can also be embodied as computer-usable instructions stored on computer storage media. The method 300 can be provided by a standalone application, a service or hosted service (standalone or in combination with another hosted service), or a plug-in to another product, to name a few. In addition, method 300 is described, by way of example, with respect to the architecture 100. However, the method 300 can additionally or alternatively be executed by any one system, or any combination of systems, including, but not limited to, those described herein.

FIG. 3 is a flow diagram showing a method 300 for performance partitioning, in accordance with some implementations of the present disclosure. The method 300 can be performed responsive to receiving (e.g., from a client, application, and/or accelerator) requests to perform memory operations. The method 300 can be performed responsive to detection of implementation of one or more workloads with different criticality levels. For example, the method 300 can be performed responsive to detection of the SoC 105 communicating with one or more applications (e.g., the applications 110) that correspond to non-safety related functions and safety related functions (e.g., mixed criticality).

The method 300, at block 302, includes assigning a threshold for bandwidth of a resource. For example, one or more circuits (e.g., a processing circuit) can assign one or more cores of a CPU to a workload (e.g., an application). As another example, the one or more circuits can allocate (e.g., assign) one or more blocks of memory (e.g., a resource) for the workload. The one or more circuits can assign the threshold based on a criticality of the workload. For example, the one or more circuits can assign a first amount of memory to the workload based on the workload being associated with safety related functions (e.g., high criticality). As another example, the one or more circuits can monitor performance and/or execution of one or more functions (e.g., safety related functions, non-safety related functions, etc.) to detect when to deallocate (e.g., unassign) a threshold of a non-safety related workload to provide additional resources to a safety related workload.

The method 300, at block 304, includes controlling execution of the workload according to the threshold. For example, the one or more circuits can designate, via one or more system calls, one or more cores to perform one or more functions associated with the workload. For example, the one or more circuits can perform one or more actions to maintain a threshold (e.g., amount of memory) for the workload. As another example, the one or more circuits can monitor retrievals and/or interactions with memory to ensure that the threshold for the workload is maintained.

The one or more circuits can assign thresholds and/or control execution of workloads by associating the thresholds with one or more partition identifiers. The one or more circuits can, based on the associations, reallocate and/or reassign resources by transmitting a system call that indicates a new threshold for a given partition identifier. The system call can remove and/or adjust the threshold for a workload associated with the given partition identifer.

The one or more circuits can assign thresholds according to one or more strict and/or non-strict ranges. For example, the one or more circuits can assign a strict maximum, for an application, such that the threshold of bandwidth assigned to the application cannot exceed the maximum. Stated otherwise, the one or more circuits can dictate/assign/specify, via the strict and/or non-strict thresholds, a given range of threshold of bandwidth for the application. The one or more circuits can assign non-strict maximum and/or non-strict minimums, such that the threshold of bandwidth for an application can fall outside of the range established by the non-strict maximum and/or non-strict minimums.

In some implementations, the one or more circuits can monitor subsequent utilization of a resource. For example, the one or more circuits can monitor utilization of memory by a workload assigned a threshold of bandwidth of memory. As another example, the one or more circuits can monitor how much of a threshold, assigned to a workload, is utilized when the workload performs one or more actions. In some implementations, the one or more circuits can determine that a difference between utilization of the resource and at least one threshold is within a threshold amount. For example, a workload may be assigned 1 gigabyte (e.g., a threshold) of memory. In this example, the subsequent utilization of the resource, by the workload, may include the workload utilizing 900 megabytes of the resource.

In some implementations, the threshold amount may define and/or dictate when to adjust (e.g., reassign, allocate, reallocate, unallocated, etc.). For example, the threshold amount may be a given percentage of an allocated amount (e.g., a threshold of bandwidth, an amount of resources, etc.). As another example, the threshold amount may be a given value (e.g., 10 megabytes, 100 kilobytes, etc.). In some implementations, the one or more circuits may adjust one or more thresholds by increasing the bandwidth of a resource that is accessible to a workload. For example, the one or more circuits may increase the bandwidth accessible by the workload by increasing the threshold from a first value to a second value.

In some implementations, the one or more circuits may adjust at least one second threshold assigned to a second workload in accordance with adjusting the threshold assigned to the workload. For example, the one or more circuits may deallocate a first amount of memory accessible to the second workload to create additional resources (e.g., portions of memory) accessible to the workload for which the threshold was increased.

In some implementations, the one or more circuits may decrease (e.g., adjust) one or more thresholds responsive to a detection that a threshold assigned to a workload exceeds an amount of resources utilized by the workload. Stated otherwise, the one or more circuits may decrease the threshold responsive to the one or more circuits determining that the amount of resources utilized by the workload is less than the threshold assigned to the workload.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed implementations may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing at least one large language model (LLM), systems implementing at least one vision language model (VLM), a system implementing at least one multi-modal language model, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

FIG. 4A is an illustration of an example autonomous or semi-autonomous vehicle or machine 400, in accordance with some implementations of the present disclosure. The autonomous vehicle 400 (alternatively referred to herein as the “vehicle 400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 400 may be capable of functionality in accordance with one or more of Level 3-Level 5 of the autonomous driving levels. The vehicle 400 may be capable of functionality in accordance with one or more of Level 1-Level 5 of the autonomous driving levels. For example, the vehicle 400 may be capable of driver assistance (Level 1), partial automation (Level 2), conditional automation (Level 3), high automation (Level 4), and/or full automation (Level 5), depending on the implementation. The term “autonomous,” as used herein, may include any and/or all types of autonomy for the vehicle 400 or other machine, such as being fully autonomous, being highly autonomous, being conditionally autonomous, being partially autonomous, providing assistive autonomy, being semi-autonomous, being primarily autonomous, or other designation.

The vehicle 400 may include components such as a chassis, a vehicle body, wheels (e.g., 2, 4, 6, 8, 18, etc.), tires, axles, and other components of a vehicle. The vehicle 400 may include a propulsion system 450, such as an internal combustion engine, hybrid electric power plant, an all-electric engine, and/or another propulsion system type. The propulsion system 450 may be connected to a drive train of the vehicle 400, which may include a transmission, to enable the propulsion of the vehicle 400. The propulsion system 450 may be controlled in response to receiving signals from the throttle/accelerator 452.

A steering system 454, which may include a steering wheel, may be used to steer the vehicle 400 (e.g., along a desired path or route) when the propulsion system 450 is operating (e.g., when the vehicle is in motion). The steering system 454 may receive signals from a steering actuator 456. The steering wheel may be optional for full automation (Level 5) functionality.

The brake sensor system 446 may be used to operate the vehicle brakes in response to receiving signals from the brake actuators 448 and/or brake sensors.

Controller(s) 436, which may include one or more system-on-a-chips (SoCs) 404 (FIG. 4C) and/or GPU(s), may provide signals (e.g., representative of commands) to one or more components and/or systems of the vehicle 400. For example, the controller(s) may send signals to operate the vehicle brakes via one or more brake actuators 448, to operate the steering system 454 via one or more steering actuators 456, to operate the propulsion system 450 via one or more throttle/accelerators 452. The controller(s) 436 may include one or more onboard (e.g., integrated) computing devices (e.g., supercomputers) that process sensor signals, and output operation commands (e.g., signals representing commands) to enable autonomous driving and/or to assist a human driver in driving the vehicle 400. The controller(s) 436 may include a first controller 436 for autonomous driving functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. In some examples, a single controller 436 may handle two or more of the above functionalities, two or more controllers 436 may handle a single functionality, and/or any combination thereof.

The controller(s) 436 may provide the signals for controlling one or more components and/or systems of the vehicle 400 in response to sensor data received from one or more sensors (e.g., sensor inputs). The sensor data may be received from, for example and without limitation, global navigation satellite systems (“GNSS”) sensor(s) 458 (e.g., Global Positioning System sensor(s)), RADAR sensor(s) 460, ultrasonic sensor(s) 462, LIDAR sensor(s) 464, inertial measurement unit (IMU) sensor(s) 466 (e.g., accelerometer(s), gyroscope(s), magnetic compass(es), magnetometer(s), etc.), microphone(s) 496, stereo camera(s) 468, wide-view camera(s) 470 (e.g., fisheye cameras), infrared camera(s) 472, surround camera(s) 474 (e.g., 360 degree cameras), long-range and/or mid-range camera(s) 498, speed sensor(s) 444 (e.g., for measuring the speed of the vehicle 400), vibration sensor(s) 442, steering sensor(s) 440, brake sensor(s) (e.g., as part of the brake sensor system 446), and/or other sensor types.

One or more of the controller(s) 436 may receive inputs (e.g., represented by input data) from an instrument cluster 432 of the vehicle 400 and provide outputs (e.g., represented by output data, display data, etc.) via a human-machine interface (HMI) display 434, an audible annunciator, a loudspeaker, and/or via other components of the vehicle 400. The outputs may include information such as vehicle velocity, speed, time, map data (e.g., the High Definition (“HD”) map 422 of FIG. 4C), location data (e.g., the vehicle's 400 location, such as on a map), direction, location of other vehicles (e.g., an occupancy grid), information about objects and status of objects as perceived by the controller(s) 436, etc. For example, the HMI display 434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 400 further includes a network interface 424 which may use one or more wireless antenna(s) 426 and/or modem(s) to communicate over one or more networks. For example, the network interface 424 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 426 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 4B is an example of camera locations and fields of view for the example autonomous vehicle 400 of FIG. 4A, in accordance with some implementations of the present disclosure. The cameras and respective fields of view are one example implementation and are not intended to be limiting. For example, additional and/or alternative cameras may be included and/or the cameras may be located at different locations on the vehicle 400.

The camera types for the cameras may include, but are not limited to, digital cameras that may be adapted for use with the components and/or systems of the vehicle 400. The camera(s) may operate at automotive safety integrity level (ASIL) B and/or at another ASIL. The camera types may be capable of any image capture rate, such as 60 frames per second (fps), 120 fps, 240 fps, etc., depending on the implementation. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some implementations, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 400 (e.g., front-facing cameras) may be used for surround view, to help identify forward facing paths and obstacles, as well aid in, with the help of one or more controllers 436 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 470 that may be used to perceive objects coming into view from the periphery (e.g., pedestrians, crossing traffic or bicycles). Although only one wide-view camera is illustrated in FIG. 4B, there may be any number (including zero) of wide-view cameras 470 on the vehicle 400. In addition, any number of long-range camera(s) 498 (e.g., a long-view stereo camera pair) may be used for depth-based object detection, especially for objects for which a neural network has not yet been trained. The long-range camera(s) 498 may also be used for object detection and classification, as well as basic object tracking.

Any number of stereo cameras 468 may also be included in a front-facing configuration. In at least one implementation, one or more of stereo camera(s) 468 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468 may be used in addition to, or alternatively from, those described herein.

Cameras with a field of view that include portions of the environment to the side of the vehicle 400 (e.g., side-view cameras) may be used for surround view, providing information used to create and update the occupancy grid, as well as to generate side impact collision warnings. For example, surround camera(s) 474 (e.g., four surround cameras 474 as illustrated in FIG. 4B) may be positioned to on the vehicle 400. The surround camera(s) 474 may include wide-view camera(s) 470, fisheye camera(s), 360 degree camera(s), and/or the like. Four example, four fisheye cameras may be positioned on the vehicle's front, rear, and sides. In an alternative arrangement, the vehicle may use three surround camera(s) 474 (e.g., left, right, and rear), and may leverage one or more other camera(s) (e.g., a forward-facing camera) as a fourth surround view camera.

Cameras with a field of view that include portions of the environment to the rear of the vehicle 400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 498, stereo camera(s) 468), infrared camera(s) 472, etc.), as described herein.

FIG. 4C is a block diagram of an example system architecture for the example autonomous vehicle 400 of FIG. 4A, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 400 in FIG. 4C are illustrated as being connected via bus 402. The bus 402 may include a Controller Area Network (CAN) data interface (alternatively referred to herein as a “CAN bus”). A CAN may be a network inside the vehicle 400 used to aid in control of various features and functionality of the vehicle 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 402 is described herein as being a CAN bus, this is not intended to be limiting. For example, in addition to, or alternatively from, the CAN bus, FlexRay and/or Ethernet may be used. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the vehicle 400, and two or more busses 402 may communicate with the same components. In some examples, each SoC 404, each controller 436, and/or each computer within the vehicle may have access to the same input data (e.g., inputs from sensors of the vehicle 400), and may be connected to a common bus, such the CAN bus.

The vehicle 400 may include one or more controller(s) 436, such as those described herein with respect to FIG. 4A. The controller(s) 436 may be used for a variety of functions. The controller(s) 436 may be coupled to any of the various other components and systems of the vehicle 400, and may be used for control of the vehicle 400, artificial intelligence of the vehicle 400, infotainment for the vehicle 400, and/or the like.

The vehicle 400 may include a system(s) on a chip (SoC) 404. The SoC 404 may include CPU(s) 406, GPU(s) 408, processor(s) 410, cache(s) 412, accelerator(s) 414, data store(s) 416, and/or other components and features not illustrated. The SoC(s) 404 may be used to control the vehicle 400 in a variety of platforms and systems. For example, the SoC(s) 404 may be combined in a system (e.g., the system of the vehicle 400) with an HD map 422 which may obtain map refreshes and/or updates via a network interface 424 from one or more servers (e.g., server(s) 478 of FIG. 4D).

The CPU(s) 406 may include a CPU cluster or CPU complex (alternatively referred to herein as a “CCPLEX”). The CPU(s) 406 may include multiple cores and/or L2 caches. For example, in some implementations, the CPU(s) 406 may include eight cores in a coherent multi-processor configuration. In some implementations, the CPU(s) 406 may include four dual-core clusters where each cluster has a dedicated L2 cache (e.g., a 2 MB L2 cache). The CPU(s) 406 (e.g., the CCPLEX) may be configured to support simultaneous cluster operation enabling any combination of the clusters of the CPU(s) 406 to be active at any given time.

The CPU(s) 406 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 408 may include an integrated GPU (alternatively referred to herein as an “iGPU”). The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some implementations, the GPU(s) 408 may include at least eight streaming microprocessors. The GPU(s) 408 may use compute application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive and embedded use cases. For example, the GPU(s) 408 may be fabricated on a Fin field-effect transistor (FinFET). However, this is not intended to be limiting and the GPU(s) 408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 406 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

In addition, the GPU(s) 408 may include an access counter that may keep track of the frequency of access of the GPU(s) 408 to memory of other processors. The access counter may help ensure that memory pages are moved to the physical memory of the processor that is accessing the pages most frequently.

The SoC(s) 404 may include any number of cache(s) 412, including those described herein. For example, the cache(s) 412 may include an L3 cache that is available to both the CPU(s) 406 and the GPU(s) 408 (e.g., that is connected both the CPU(s) 406 and the GPU(s) 408). The cache(s) 412 may include a write-back cache that may keep track of states of lines, such as by using a cache coherence protocol (e.g., MEI, MESI, MSI, etc.). The L3 cache may include 4 MB or more, depending on the implementation, although smaller cache sizes may be used.

The SoC(s) 404 may include an arithmetic logic unit(s) (ALU(s)) which may be leveraged in performing processing with respect to any of the variety of tasks or operations of the vehicle 400—such as processing DNNs. In addition, the SoC(s) 404 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 408, and by using an inference accelerator, for example, a designer may target either the DLA(s) or the GPU(s) 408 for any function. For example, the designer may focus processing of CNNs and floating point operations on the DLA(s) and leave other functions to the GPU(s) 408 and/or other accelerator(s) 414.

The accelerator(s) 414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the implementation. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some implementations, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 414 (e.g., the hardware acceleration cluster) may include a computer vision network on-chip and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 404 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some implementations, one or more tree traversal units (TTUs) may be used for executing one or more ray-tracing related operations.

The accelerator(s) 414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one implementation of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 466 output that correlates with the vehicle 400 orientation, distance, 3D location estimates of the object obtained from the neural network and/or other sensors (e.g., LIDAR sensor(s) 464 or RADAR sensor(s) 460), among others.

The SoC(s) 404 may include data store(s) 416 (e.g., memory). The data store(s) 416 may be on-chip memory of the SoC(s) 404, which may store neural networks to be executed on the GPU and/or the DLA. In some examples, the data store(s) 416 may be large enough in capacity to store multiple instances of neural networks for redundancy and safety. The data store(s) 412 may comprise L2 or L3 cache(s) 412. Reference to the data store(s) 416 may include reference to the memory associated with the PVA, DLA, and/or other accelerator(s) 414, as described herein.

The SoC(s) 404 may include one or more processor(s) 410 (e.g., embedded processors). The processor(s) 410 may include a boot and power management processor that may be a dedicated processor and subsystem to handle boot power and management functions and related security enforcement. The boot and power management processor may be a part of the SoC(s) 404 boot sequence and may provide runtime power management services. The boot power and management processor may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, and/or accelerator(s) 414. If temperatures are determined to exceed a threshold, the boot and power management processor may enter a temperature fault routine and put the SoC(s) 404 into a lower power state and/or put the vehicle 400 into a chauffeur to safe stop mode (e.g., bring the vehicle 400 to a safe stop).

The processor(s) 410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 410 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 410 may further include a real-time camera engine that may include a dedicated processor subsystem for handling real-time camera management.

The processor(s) 410 may further include a high-dynamic range signal processor that may include an image signal processor that is a hardware engine that is part of the camera processing pipeline.

The processor(s) 410 may include a video image compositor that may be a processing block (e.g., implemented on a microprocessor) that implements video post-processing functions needed by a video playback application to produce the final image for the player window. The video image compositor may perform lens distortion correction on wide-view camera(s) 470, surround camera(s) 474, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and active doing 3D rendering, the video image compositor may be used to offload the GPU(s) 408 to improve performance and responsiveness.

The SoC(s) 404 may further include a mobile industry processor interface (MIPI) camera serial interface for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role.

The SoC(s) 404 may further include a broad range of peripheral interfaces to enable communication with peripherals, audio codecs, power management, and/or other devices. The SoC(s) 404 may be used to process data from cameras (e.g., connected over Gigabit Multimedia Serial Link and Ethernet), sensors (e.g., LIDAR sensor(s) 464, RADAR sensor(s) 460, etc. that may be connected over Ethernet), data from bus 402 (e.g., speed of vehicle 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks.

The SoC(s) 404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 420) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 408.

In some examples, a CNN for facial recognition and vehicle owner identification may use data from camera sensors to identify the presence of an authorized driver and/or owner of the vehicle 400. The always on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or carjacking.

In another example, a CNN for emergency vehicle detection and identification may use data from microphones 496 to detect and identify emergency vehicle sirens. In contrast to conventional systems, that use general classifiers to detect sirens and manually extract features, the SoC(s) 404 use the CNN for classifying environmental and urban sounds, as well as classifying visual data. In a preferred implementation, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 462, until the emergency vehicle(s) passes.

The vehicle may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The vehicle 400 may include a GPU(s) 420 (e.g., discrete GPU(s), or dGPU(s)), that may be coupled to the SoC(s) 404 via a high-speed interconnect (e.g., NVIDIA's NVLINK). The GPU(s) 420 may provide additional artificial intelligence functionality, such as by executing redundant and/or different neural networks, and may be used to train and/or update neural networks based on input (e.g., sensor data) from sensors of the vehicle 400.

The vehicle 400 may further include the network interface 424 which may include one or more wireless antennas 426 (e.g., one or more wireless antennas for different communication protocols, such as a cellular antenna, a Bluetooth antenna, etc.). The network interface 424 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 400 information about vehicles in proximity to the vehicle 400 (e.g., vehicles in front of, on the side of, and/or behind the vehicle 400). This functionality may be part of a cooperative adaptive cruise control functionality of the vehicle 400.

The network interface 424 may include a SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 400 may further include data store(s) 428 which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The vehicle 400 may further include GNSS sensor(s) 458. The GNSS sensor(s) 458 (e.g., GPS, assisted GPS sensors, differential GPS (DGPS) sensors, etc.), to assist in mapping, perception, occupancy grid generation, and/or path planning functions. Any number of GNSS sensor(s) 458 may be used, including, for example and without limitation, a GPS using a USB connector with an Ethernet to Serial (RS-232) bridge.

The vehicle 400 may further include RADAR sensor(s) 460. The RADAR sensor(s) 460 may be used by the vehicle 400 for long-range vehicle detection, even in darkness and/or severe weather conditions. RADAR functional safety levels may be ASIL B. The RADAR sensor(s) 460 may use the CAN and/or the bus 402 (e.g., to transmit data generated by the RADAR sensor(s) 460) for control and to access object tracking data, with access to Ethernet to access raw data in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 400 surroundings at higher speeds with minimal interference from traffic in adjacent lanes. The other two antennae may expand the field of view, making it possible to quickly detect vehicles entering or leaving the vehicle's 400 lane.

Mid-range RADAR systems may include, as an example, a range of up to 460 m (front) or 80 m (rear), and a field of view of up to 42 degrees (front) or 450 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 400 may further include ultrasonic sensor(s) 462. The ultrasonic sensor(s) 462, which may be positioned at the front, back, and/or the sides of the vehicle 400, may be used for park assist and/or to create and update an occupancy grid. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B.

The vehicle 400 may include LIDAR sensor(s) 464. The LIDAR sensor(s) 464 may be used for object and pedestrian detection, emergency braking, collision avoidance, and/or other functions. The LIDAR sensor(s) 464 may be functional safety level ASIL B. In some examples, the vehicle 400 may include multiple LIDAR sensors 464 (e.g., two, four, six, etc.) that may use Ethernet (e.g., to provide data to a Gigabit Ethernet switch).

In some examples, the LIDAR sensor(s) 464 may be capable of providing a list of objects and their distances for a 360-degree field of view. Commercially available LIDAR sensor(s) 464 may have an advertised range of approximately 400 m, with an accuracy of 2 cm-3 cm, and with support for a 400 Mbps Ethernet connection, for example. In some examples, one or more non-protruding LIDAR sensors 464 may be used. In such examples, the LIDAR sensor(s) 464 may be implemented as a small device that may be embedded into the front, rear, sides, and/or corners of the vehicle 400. The LIDAR sensor(s) 464, in such examples, may provide up to a 120-degree horizontal and 35-degree vertical field-of-view, with a 200 m range even for low-reflectivity objects. Front-mounted LIDAR sensor(s) 464 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 400. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 464 may be less susceptible to motion blur, vibration, and/or shock.

The vehicle may further include IMU sensor(s) 466. The IMU sensor(s) 466 may be located at a center of the rear axle of the vehicle 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some implementations, the IMU sensor(s) 466 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may enable the vehicle 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include microphone(s) 496 placed in and/or around the vehicle 400. The microphone(s) 496 may be used for emergency vehicle detection and identification, among other things.

The vehicle may further include any number of camera types, including stereo camera(s) 468, wide-view camera(s) 470, infrared camera(s) 472, surround camera(s) 474, long-range and/or mid-range camera(s) 498, and/or other camera types. The cameras may be used to capture image data around an entire periphery of the vehicle 400. The types of cameras used depends on the implementations and requirements for the vehicle 400, and any combination of camera types may be used to provide the necessary coverage around the vehicle 400. In addition, the number of cameras may differ depending on the implementation. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 4A and FIG. 4B.

The vehicle 400 may further include vibration sensor(s) 442. The vibration sensor(s) 442 may measure vibrations of components of the vehicle, such as the axle(s). For example, changes in vibrations may indicate a change in road surfaces. In another example, when two or more vibration sensors 442 are used, the differences between the vibrations may be used to determine friction or slippage of the road surface (e.g., when the difference in vibration is between a power-driven axle and a freely rotating axle).

The vehicle 400 may include an ADAS system 438. The ADAS system 438 may include a SoC, in some examples. The ADAS system 438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 460, LIDAR sensor(s) 464, and/or a camera(s). The ACC systems may include longitudinal ACC and/or lateral ACC. Longitudinal ACC monitors and controls the distance to the vehicle immediately ahead of the vehicle 400 and automatically adjust the vehicle speed to maintain a safe distance from vehicles ahead. Lateral ACC performs distance keeping, and advises the vehicle 400 to change lanes when necessary. Lateral ACC is related to other ADAS applications such as LCA and CWS.

CACC uses information from other vehicles that may be received via the network interface 424 and/or the wireless antenna(s) 426 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 400), while the I2V communication concept provides information about traffic further ahead. CACC systems may include either or both I2V and V2V information sources. Given the information of the vehicles ahead of the vehicle 400, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 400 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 400 if the vehicle 400 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 460, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 400 is backing up. Some RCTW systems include AEB to ensure that the vehicle brakes are applied to avoid a crash. RCTW systems may use one or more rear-facing RADAR sensor(s) 460, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 400, the vehicle 400 itself must, in the case of conflicting results, decide whether to heed the result from a primary computer or a secondary computer (e.g., a first controller 436 or a second controller 436). For example, in some implementations, the ADAS system 438 may be a backup and/or secondary computer for providing perception information to a backup computer rationality module. The backup computer rationality monitor may run a redundant diverse software on hardware components to detect faults in perception and dynamic driving tasks. Outputs from the ADAS system 438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In implementations that include a neural network(s) running on the supervisory MCU, the supervisory MCU may include at least one of a DLA or GPU suitable for running the neural network(s) with associated memory. In preferred implementations, the supervisory MCU may comprise and/or be included as a component of the SoC(s) 404.

In other examples, ADAS system 438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 438 may be fed into the primary computer's perception block and/or the primary computer's dynamic driving task block. For example, if the ADAS system 438 indicates a forward crash warning due to an object immediately ahead, the perception block may use this information when identifying objects. In other examples, the secondary computer may have its own neural network which is trained and thus reduces the risk of false positives, as described herein.

The vehicle 400 may further include the infotainment SoC 430 (e.g., an in-vehicle infotainment system (IVI)). Although illustrated and described as a SoC, the infotainment system may not be a SoC, and may include two or more discrete components. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 400. For example, the infotainment SoC 430 may radios, disk players, navigation systems, video players, USB and Bluetooth connectivity, carputers, in-car entertainment, Wi-Fi, steering wheel audio controls, hands free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the vehicle 400. In some examples, the infotainment SoC 430 may be coupled to a supervisory MCU such that the GPU of the infotainment system may perform some self-driving functions in the event that the primary controller(s) 436 (e.g., the primary and/or backup computers of the vehicle 400) fail. In such an example, the infotainment SoC 430 may put the vehicle 400 into a chauffeur to safe stop mode, as described herein.

The vehicle 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. In other words, the instrument cluster 432 may be included as part of the infotainment SoC 430, or vice versa.

FIG. 4D is a system diagram for communication between cloud-based server(s) and the example autonomous vehicle 400 of FIG. 4A, in accordance with some implementations of the present disclosure. The system 476 may include server(s) 478, network(s) 490, and vehicles, including the vehicle 400. The server(s) 478 may include a plurality of GPUs 484(A)-484(H) (collectively referred to herein as GPUs 484), PCIe switches 482(A)-482(H) (collectively referred to herein as PCIe switches 482), and/or CPUs 480(A)-480(B) (collectively referred to herein as CPUs 480). The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the implementation, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the vehicles, image data representative of images showing unexpected or changed road conditions, such as recently commenced road-work. The server(s) 478 may transmit, over the network(s) 490 and to the vehicles, neural networks 492, updated neural networks 492, and/or map information 494, including information regarding traffic and road conditions. The updates to the map information 494 may include updates for the HD map 422, such as information regarding construction sites, potholes, detours, flooding, and/or other obstructions. In some examples, the neural networks 492, the updated neural networks 492, and/or the map information 494 may have resulted from new training and/or experiences represented in data received from any number of vehicles in the environment, and/or based on training performed at a datacenter (e.g., using the server(s) 478 and/or other servers).

The server(s) 478 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 490, and/or the machine learning models may be used by the server(s) 478 to remotely monitor the vehicles.

In some examples, the server(s) 478 may receive data from the vehicles and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in the vehicle 400. For example, the deep-learning infrastructure may receive periodic updates from the vehicle 400, such as a sequence of images and/or objects that the vehicle 400 has located in that sequence of images (e.g., via computer vision and/or other machine learning object classification techniques). The deep-learning infrastructure may run its own neural network to identify the objects and compare them with the objects identified by the vehicle 400 and, if the results do not match and the infrastructure concludes that the AI in the vehicle 400 is malfunctioning, the server(s) 478 may transmit a signal to the vehicle 400 instructing a fail-safe computer of the vehicle 400 to assume control, notify the passengers, and complete a safe parking maneuver.

For inferencing, the server(s) 478 may include the GPU(s) 484 and one or more programmable inference accelerators (e.g., NVIDIA's Tensor®. The combination of GPU-powered servers and inference acceleration may make real-time responsiveness possible. In other examples, such as where performance is less critical, servers powered by CPUs, FPGAs, and other processors may be used for inferencing.

FIG. 5 is a block diagram of an example computing device(s) 500 suitable for use in implementing some implementations of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In implementations, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In implementations, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one implementation, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system, comprising:
one or more circuits to:
assign, to a workload for execution on a system-on-a-chip (SoC) and according to a criticality of the workload, at least one threshold for bandwidth of a resource of the SoC; and
control execution of the workload according to the at least one threshold.

2. The system of claim 1, wherein the criticality corresponds to an automotive safety integrity level (ASIL) associated with the workload.

3. The system of claim 1, wherein the resource comprises at least one of a memory element, an interconnect, or a cache of the SoC.

4. The system of claim 1, wherein the one or more circuits are to assign the at least one threshold, responsive to the criticality indicating that the workload satisfies a high criticality condition, to include a minimum threshold bandwidth to allocate to the workload and a maximum threshold bandwidth to selectively limit allocation of the resource to the workload responsive to the resource being in a state of contention.

5. The system of claim 1, wherein the workload is a first workload, the at least one threshold is at least one first threshold, and the criticality is a first criticality, and the one or more circuits are to assign, to a second workload having a second criticality lower than the first criticality, at least one second maximum threshold for the bandwidth of the resource such that the one or more circuits prevent interference of the second workload with the first workload.

6. The system of claim 1, wherein the one or more circuits are to execute the workload using a partition associated with the SoC, and the one or more circuits are to map the at least one threshold to an identifier of the partition.

7. The system of claim 1, wherein the system is comprised in at least one of:
a control system for an autonomous or semi-autonomous machine;
a perception system for an autonomous or semi-autonomous machine;
a system incorporating one or more virtual machines (VMs);
a system implemented using a robot;
a system implemented using an edge device;
a system for generating synthetic data;
a system comprising one or more large language models (LLMs);
a system comprising one or more vision language models (VLMs);
a system comprising one or more multi-modal language models;
a system for performing conversational AI operations;
a system for performing deep learning operations;
a system for performing simulation operations;
a system for performing collaborative content creation for 3D assets;
a system for performing digital twin operations;
a system for performing light transport simulation;
a system implemented at least partially in a data center; or
a system implemented at least partially using cloud computing resources.

8. The system of claim 1, wherein the one or more circuits are to:
monitor, responsive to assignment of the at least one threshold to the workload, subsequent utilization of the resource by the workload;
determine that a difference between the subsequent utilization of the resource and the at least one threshold is within a first threshold amount; and
adjust the at least one threshold assigned to the workload by increasing the bandwidth of the resource accessible by the workload.

9. The system of claim 8, wherein the one or more circuits are to:
adjust at least one second threshold assigned to a second workload, the at least one second threshold associated with a second bandwidth of the resource;
wherein the adjustment of the at least one threshold is in accordance with the adjustment of the at least one second threshold.

10. The system of claim 1, wherein the one or more circuits are to:
detect, responsive to monitoring subsequent utilization of the resource by the workload, that the at least one threshold assigned to the workload exceeds at least one second threshold of the bandwidth of the resource, wherein the at least one second threshold of the bandwidth corresponds to the subsequent utilization of the resource; and
adjust the at least one threshold assigned to workload to reflect the at least one second threshold.

11. A system-on-a-chip (SoC), comprising:
one or more circuits to:
assign, to a workload for execution on the SoC and according to a criticality of the workload, at least one threshold for bandwidth of a resource of the SoC; and
control execution of the workload according to the at least one threshold.

12. The SoC of claim 11, wherein the criticality corresponds to an automotive safety integrity level (ASIL) associated with the workload.

13. The SoC of claim 11, wherein the resource comprises at least one of a memory element, an interconnect, or a cache of the SoC.

14. The SoC of claim 11, wherein the one or more circuits are to assign the at least one threshold, responsive to the criticality indicating that the workload satisfies a high criticality condition, to include a minimum threshold bandwidth to allocate to the workload and a maximum threshold bandwidth to selectively limit allocation of the resource to the workload responsive to the resource being in a state of contention.

15. The SoC of claim 11, wherein the workload is a first workload, the at least one threshold is at least one first threshold, and the criticality is a first criticality, and the one or more circuits are to assign, to a second workload having a second criticality lower than the first criticality, at least one second maximum threshold for the bandwidth of the resource such that the one or more circuits prevent interference of the second workload with the first workload.

16. The SoC of claim 11, wherein the one or more circuits are to execute the workload using a partition associated with the SoC, and the one or more circuits are to map the at least one threshold to an identifier of the partition.

17. A method, comprising:
assigning, using one or more circuits, to a workload for execution on a system-on-a-chip (SoC) and according to a criticality of the workload, at least one threshold for bandwidth of a resource of the SoC; and
controlling, using the one or more circuits, execution of the workload according to the at least one threshold.

18. The method of claim 17, wherein the criticality corresponds to an automotive safety integrity level (ASIL) associated with the workload.

19. The method of claim 17, wherein the resource comprises at least one of a memory element, an interconnect, or a cache of the SoC.

20. The method of claim 17, further comprising:
assigning, using the one or more circuits, the at least one threshold, responsive to the criticality indicating that the workload satisfies a high criticality condition, to include a minimum threshold bandwidth to allocate to the workload and a maximum threshold bandwidth to selectively limit allocation of the resource to the workload responsive to the resource being in a state of contention.
